(19) United States
(12) Patent Application Publication
(10) Pub. No.: US 2026/0280463 A1
(43) Pub. Date: Sep. 17, 2026

(54) DATA DISTRIBUTION IN A MULTI-INVERTER ELECTRIC MACHINE

(71) Applicant: Cummins Inc., Columbus, IN (US)

(72) Inventors: Jaroslaw Leonarski, Columbus, IN (US); Michael Kercher, Evansville, IN (US); Zachary Ryan Gheaja, Columbus, IN (US)

(21) Appl. No.: 19/473,070

(22) PCT Filed: May 15, 2024
(86) PCT No.: PCT/US2024/029407

§ 371 Date: Oct. 6, 2025

Related U.S. Application Data
(60) Provisional application No. 63/466,545, filed on May 15, 2023.

(51) Int. Cl. H02P 23/14

(52) U.S. Cl. CPC H02P 23/14

(57) ABSTRACT

Disclosed herein are devices, systems, and methods relating to controlling an electric machine. In an example, a method can include obtaining first position data corresponding to a rotor of an electric machine. The first position data can include numeric data indicating a speed and an angle of the rotor. The first position data can further include signal data indicating an angle of the rotor. The method can further include determining, at a first time, by comparing the speed to a threshold, that the speed exceeds the threshold. The method can further include generating a calculated speed and a calculated angle of the rotor. The generating can be based on the signal data. The generating can further be in response to the determining at the first time that the speed exceeds the threshold. The method can further include storing the calculated speed and the calculated angle for controlling the electric machine.

### FIELD

The present disclosure relates to data distribution in an electric machine, and more specifically, to data distribution in an electric machine having a multi-inverter architecture.

### BACKGROUND

An electric machine (e.g., an induction motor and/or generator) can include a controller that controls the electric machine based on information regarding the speed and position of a rotor of the electric machine. A position sensor can provide such information. The electric machine can further include an inverter configured to provide torque in response to a torque command.

### SUMMARY

According to embodiments of the present disclosure, a method can include obtaining first position data corresponding to a rotor of an electric machine. The first position data can include numeric data indicating a speed and an angle of the rotor. The first position data can further include signal data indicating an angle of the rotor. The method can further include determining, at a first time, by comparing the speed to a threshold, that the speed exceeds the threshold. The method can further include generating a calculated speed and a calculated angle of the rotor. The generating can be based on the signal data. The generating can further be in response to the determining at the first time that the speed exceeds the threshold. The method can further include storing the calculated speed and the calculated angle for controlling the electric machine.

According to embodiments of the present disclosure, a system can include an electric machine having a rotor and a set of inverter components. The system can further include a position sensor configured to generate sensor data corresponding to a position of the rotor. The system can further include a controller communicably coupled to both the position sensor and the set of inverter components. The controller can be configured to obtain the sensor data. The controller can be further configured to generate position data. The position data can be based on the sensor data. The controller can be further configured to transmit the position data to each inverter component of the set of inverter components.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 depicts an example vehicle having an electric machine, in accordance with embodiments of the present disclosure.

FIG. 2 depicts a flowchart of an example method for a sub-controller of an electric machine, in accordance with embodiments of the present disclosure.

FIG. 3 depicts a flowchart of an example method for a supervisory controller of an electric machine, in accordance with embodiments of the present disclosure.

FIG. 4 depicts an example multi-inverter electric machine, in accordance with embodiments of the present disclosure.

FIG. 5 depicts an example configuration of a differential communication channel, in accordance with embodiments of the present disclosure.

FIG. 6 depicts an example control system configuration, in accordance with embodiments of the present disclosure.

FIG. 7 depicts an example computing device that can be used in accordance with embodiments of the present disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The present disclosure relates to data distribution in an electric machine; more particular aspects relate to data distribution in an electric machine having a multi-inverter architecture.

As noted above, a controller can be configured to control an electric machine (e.g., a permanent magnet motor and/or generator) based on rotor speed and position information from a position sensor. In some electric machine configurations, inaccuracies can be introduced during the distribution of position data from the controller. For example, position data distributed by a controller via a controller area network (“CAN”) bus may have higher accuracy at lower rotor speeds (e.g., rotor speeds between approximately 100 and 900 revolutions-per-minute (“RPM”), or less) than at higher rotor speeds (e.g., rotor speeds between approximately 1,000 and 10,000 RPM, or greater), due to latency of the data. Such inaccuracies may be particularly undesirable for an electric machine having a multi-inverter architecture (e.g., a configuration in which each of a plurality of segmented inverter components of the electric machine is separately and independently operable), where position data is distributed to a plurality of inverter components to control the electric machine. Additionally, in an electric machine having such a multi-inverter architecture, employing a plurality of position sensors (e.g., a respective position sensor configured with each of the plurality of inverter components) may introduce structural and operational inefficiencies and increase the total system costs.

To address these and other challenges, embodiments of the present disclosure include devices, methods, and systems for distributing data in an electric machine. Some embodiments of the present disclosure can be configured to control an electric machine based on a first type of data or a second type of data, depending on a rotor speed of the electric machine. For example, in some embodiments, for rotor speeds of 0 RPM to 200 RPM, an inverter component can control an electric machine using rotor speed and angle values obtained by a CAN bus. Additionally in this example, for rotor speeds of 200 RPM to 12,000 RPM, the inverter component can control the electric machine using a pulse width modulation (“PWM”) signal representing a rotor angle and obtained by a differential communication channel. Embodiments of the present disclosure can further include hysteresis. For example, in some embodiments, for rotor speeds during an acceleration from 0 RPM to 300 RPM, an inverter component can control an electric machine using rotor speed and angle values obtained by a CAN bus. At 300 RPM, the inverter component can transition to controlling the electric machine using a PWM signal representing rotor angle and obtained by a differential communication channel. Further in this example, during deceleration from 12,000 RPM to 0 RPM, the inverter component can transition back to using rotor speed and angle values obtained by the CAN bus in response to the speed reaching 200 RPM.

Embodiments of the present disclosure can be configured to obtain rotor position and/or speed information from a single position sensor, and distribute, by a supervisory controller, such information to each inverter component of an electric machine having a multi-inverter architecture. Such a configuration can permit the use of a reduced number of data connections for providing position information to the inverter components. Embodiments of the present disclosure can be configured to distribute rotor position and/or speed information by a plurality of communication channels. Accordingly, embodiments of the present disclosure can facilitate improved control of an electric machine by providing rotor position and/or speed information having improved accuracy. Additionally, embodiments of the present disclosure provide structurally and operationally efficient configurations for distributing data for controlling a multi-inverter electric machine.

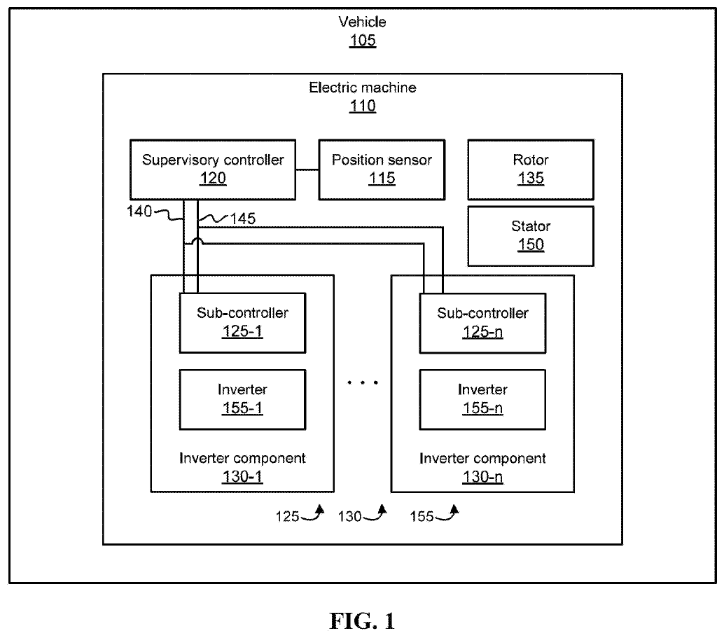

Turning to the figures, FIG. 1 illustrates an example vehicle 105 (e.g., a hybrid or electric vehicle) having an electric machine 110, in accordance with embodiments of the present disclosure. While FIG. 1 discloses electric machine 110 as a component of vehicle 105, this disclosure is not limited to vehicle applications. Thus, in some embodiments, electric machine 110 can be employed in non-vehicular devices in which mechanical energy is converted to electrical energy and/or electrical energy is converted to mechanical energy.

Electric machine 110 includes a rotor 135 coupled with a stator 150. Electric machine 110 further includes a supervisory controller 120 communicably coupled to position sensor 115. Accordingly, supervisory controller 120 and position sensor 115 can exchange data by a communication channel such as a data cable and/or a wireless network connection. Position sensor 115 is configured to detect a position (e.g., angle) of rotor 135 and generate sensor data (e.g., one or more signals) corresponding to the position. Position sensor 115 can include a device such as a resolver, encoder, hall sensor, and/or inductive sensor. For example, in some embodiments, position sensor 115 can include a resolver that detects an angle of rotation of rotor 135 with respect to time and generates sine and cosine signals that represent the angle. In this example, position sensor 115 can transmit such signals to supervisory controller 120 by a data cable, such as a data cable configured to transmit differential signals.

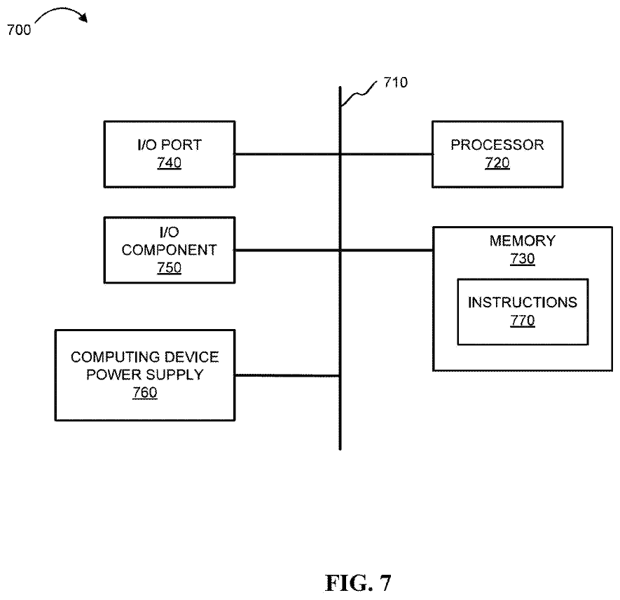

Supervisory controller 120 and each sub-controller 125-n can include a computing device, such as illustrative computing device 700, FIG. 7. Supervisory controller 120 is configured to operate electric machine 110 by the set of inverter components 130. For example, supervisory controller 120 is configured to receive a torque command for the electric machine (e.g., a torque request from vehicle 105) and issue a command to one or more sub-controllers 125-n to operate one or more respective inverters 155-n based on the torque command. In some embodiments, supervisory controller 120 is configured to issue a command to one or more sub-controllers 125-n to operate one or more respective inverters 155-n based, at least in part, on operation efficiency (e.g., an optimum operating efficiency to meet a torque command). In a further example, vehicle 105 can be an electric vehicle having electric machine 110. Continuing with this example, during operation of vehicle 105, a vehicle operator can initiate a torque request from vehicle 105 to electric machine 110 by pressing an accelerator pedal of vehicle 105. In response to such a torque request, supervisory controller 110 can issue a command to three sub-controllers 125-n of a set of four sub-controllers 125. Continuing with this example, in response to the command, the three sub-controllers 125-n can operate three respective inverters 155-n to generate a torque based on the torque request. Additionally in this example, the command from supervisory controller 110 to operate three of four sub-controllers 125-n can be based on a determination by the supervisory controller that three, rather than four, inverters can satisfy the torque request with optimum efficiency.

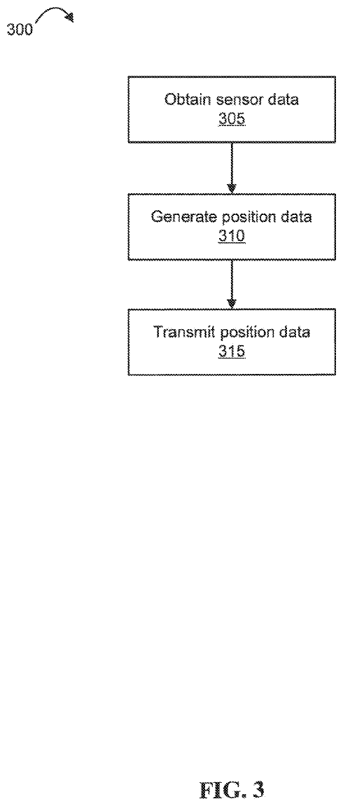

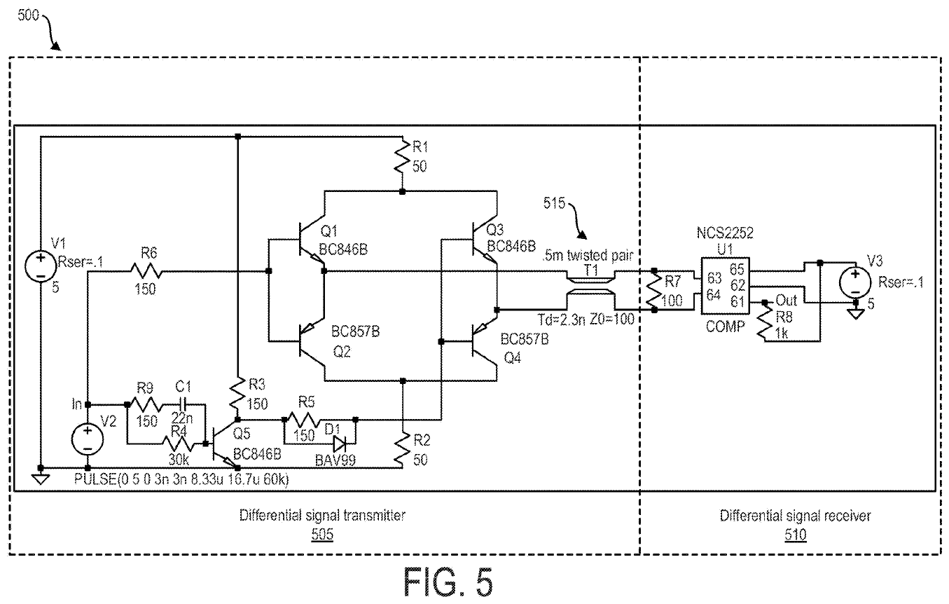

Supervisory controller 120 is further configured to perform one or more operations discussed with respect to FIG. 3. Thus, supervisory controller 120 can include program instructions implemented by one or more processors to obtain (e.g., receive and/or retrieve) sensor data from position sensor 115; generate, based on the sensor data, position data corresponding to a position of the rotor 135; and transmit the position data to each inverter component 130-n of the set of inverter components 130. Supervisory controller 120 is configured to transmit data to each inverter component 130-n by first communication channel 140 and/or second communication channel 145. In some embodiments, first communication channel 140 can include a CAN bus (e.g., a CAN bus of vehicle 105). In some embodiments, second communication channel 145 can include a differential communication channel. In an example differential communication channel, supervisory controller 120 can include a differential signal transmitter, and each inverter component 130-n can include a differential signal receiver. Continuing with this example, supervisory controller 120 can transmit data to each inverter component 130-n by a differential conductor such as a differential two-wire cable. In some embodiments, first communication channel 140 and second communication channel 145 can be discrete (e.g., separately and independently operable) communication channels. In some embodiments, second communication channel 145 can include a differential communication channel that is separate and independent from a CAN bus. In some embodiments, second communication channel 145 can be identical or substantially similar to differential communication channel 500, FIG. 5. By using a differential conductor (e.g., two wires without ground) in a differential communication channel as disclosed, embodiments of the present disclosure can improve resistance to electromagnetic interference. In some embodiments, a single-ended line with one signal line and ground can be used. In some embodiments, supervisory controller 120 and one or more sub-controllers 125-n can communicate by low-voltage (e.g., approximately 5V or less) data signals.

The set of inverter components 130 includes one or more inverter components. For example, in some embodiments, the set of inverter components 130 can include n inverter components, where n is an integer greater than 0. For example, n=1 in embodiments in which the set of inverter components 130 includes only a first inverter component 130-1; n=2 in embodiments in which the set of inverter components 130 includes two inverter components (a first inverter component 130-1 and a second inverter component 130-2); and so on. Each inverter component 130-n includes a respective sub-controller 125-n and a respective inverter 155-n.

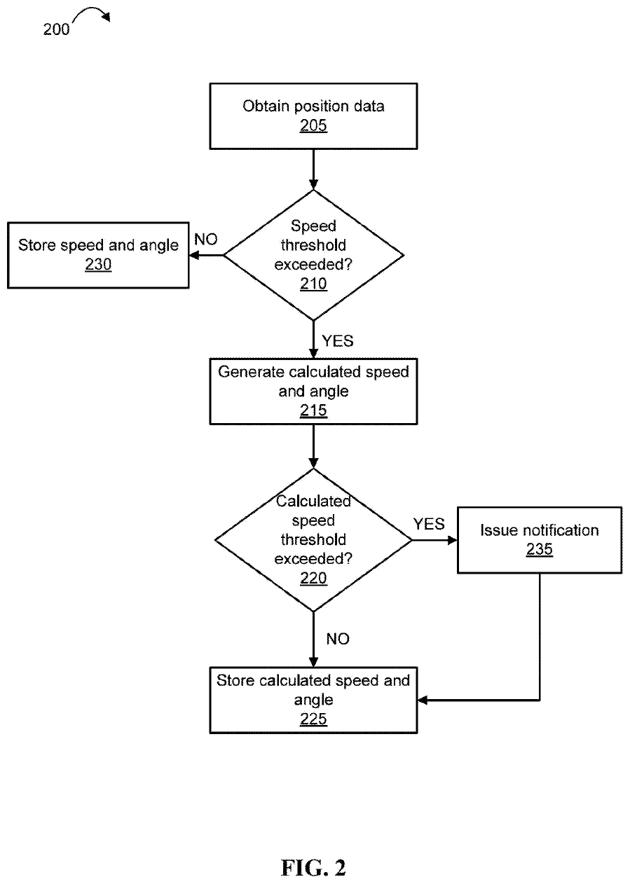

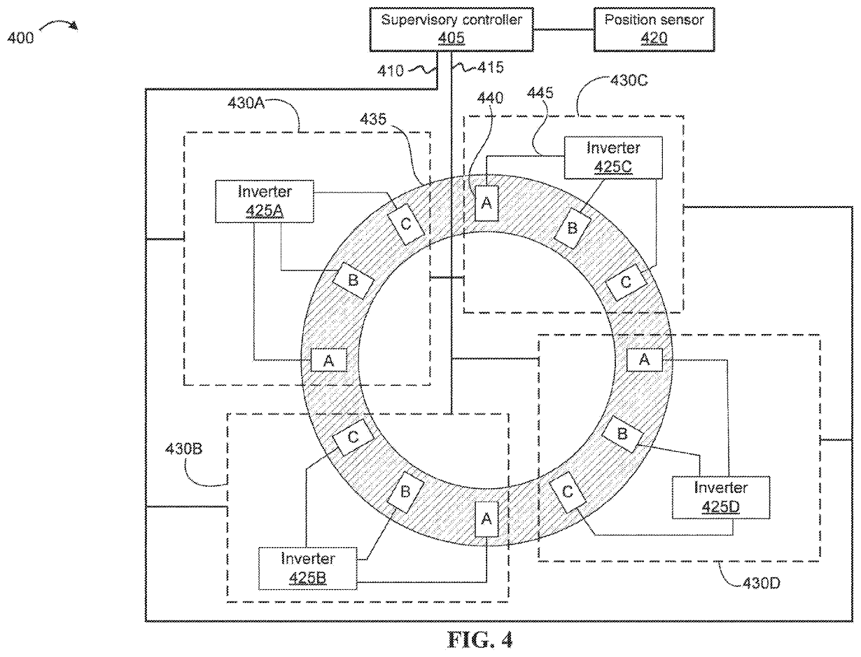

Sub-controller 125-n can include program instructions implemented by one or more processors to perform one or more operations discussed with respect to FIG. 2. In some embodiments, one or more sub-controllers 125-n can be integrated into supervisory controller 120. Inverter 155-n includes one or more coil windings that form one or more inductors that can apply torque to rotor 135. In some embodiments, electric machine 110 can be identical or substantially similar to multi-inverter electric machine 400 discussed with respect to FIG. 4. In some embodiments, inverter component 130-n and inverter 155-n can be identical or substantially similar to segmented inverter component 430A and inverter 425A, respectively, discussed with respect to FIG. 4.

FIG. 2 illustrates a flowchart of an example method 200 for a sub-controller (e.g., sub-controller 125-n, FIG. 1) of an inverter component, in accordance with embodiments of the present disclosure.

In operation 205, the sub-controller obtains position data. Position data can indicate a position and/or speed of a rotor (e.g., rotor 135, FIG. 1). For example, in some embodiments, position data can include numeric data (e.g., one or more numeric values) indicating rotor speed and/or angle (e.g., 200 RPM, 90°). Additionally in this example, the sub-controller can obtain such values by a CAN bus. In some embodiments, position data can include signal data (e.g., a signal representing rotor angle). Additionally in this example, the sub-controller can obtain such signal data by a differential communication channel (e.g., second communication channel 145, FIG. 1). In some embodiments, the sub-controller obtains (e.g., receives and/or retrieves) position data from a controller (e.g., supervisory controller 120, FIG. 1).

In operation 210, the sub-controller determines whether a speed threshold is exceeded. In some embodiments, operation 210 can include the sub-controller comparing position data obtained in operation 205 (e.g., a speed value obtained by a CAN bus) to threshold. For example, in some embodiments, the position data can include a rotor speed (e.g., 8,000 RPM), and operation 210 can include comparing the rotor speed to a threshold (e.g., 200 RPM) and determining whether the rotor speed is greater than the threshold. Such a threshold can be stored in memory, such as in memory of a supervisory controller and/or sub-controller. In response to determining that the threshold is exceeded, the sub-controller proceeds to operation 215. Alternatively, in response to determining that the threshold is not exceeded, the sub-controller proceeds to operation 230.

In operation 230, the sub-controller stores a speed and angle for controlling the electric machine. For example, in some embodiments, the sub-controller uses the speed and angle values obtained in operation 205 in a segmented inverter control algorithm to control the machine segment torque (e.g., a torque generated by an inverter 155-n). In some embodiments, in response to performing operation 230, the sub-controller can proceed to operation 205 and perform a subsequent iteration of method 200.

In operation 215, the sub-controller generates, based on position data obtained in operation 205, a calculated speed and angle. For example, in some embodiments, operation 215 can include the sub-controller converting signal data (e.g., a pulse width modulation (“PWM”) signal representing a rotor angle) to an angle value and a speed value. Such converting can include scaling the angle minimum to 10% of the duty cycle and the maximum to 90% of the duty cycle, and a calculating based on the following relationship:
duty cycle PWM=(angle/360)*80%+10%.

In operation 220, the sub-controller determines whether a calculated speed threshold is exceeded. In some embodiments, operation 220 can include the sub-controller comparing a calculated speed generated in operation 215 to a rotor speed value obtained in operation 205 and determining whether a difference between such values exceeds a threshold, such as a percentage difference of approximately 1% to 5%. For example, in some embodiments, in operation 215, the sub-controller can generate a calculated speed of 15,000 RPM. Continuing with this example, the sub-controller can compare the calculated speed with a 14,200 RPM rotor speed value obtained by a CAN bus in operation 205. Based on the comparison, the sub-controller can determine that the percentage difference between the values is greater than a threshold of 5%; thus, the threshold is exceeded. In some instances, such an exceeded threshold can indicate a fault or malfunction in the electric machine. In response to determining that the calculated speed threshold is exceeded, the sub-controller proceeds to operation 235. Alternatively, in response to determining that the calculated speed threshold is not exceeded, the sub-controller proceeds to operation 225.

In operation 225, the sub-controller stores a calculated speed and angle. For example, in some embodiments, the sub-controller uses the calculated speed and angle values generated in operation 215 in a segmented inverter control algorithm to control the machine segment torque (e.g., a torque generated by an inverter 155-n). In some embodiments, in response to performing operation 225, the sub-controller can proceed to operation 205 and perform a subsequent iteration of method 200.

In operation 235, the sub-controller issues a notification. In some embodiments, issuing a notification can include the sub-controller transmitting data indicating that a fault or malfunction may be present. For example, in some embodiments, operation 235 can include the sub-controller transmitting an alarm signal to a supervisory controller of the electric machine or to an apparatus, such as a vehicle, in which the electric machine is disposed. The alarm signal can indicate a fault or malfunction in the electric machine and/or an inverter component of the electric machine. In some instances, such a notification can initiate stopping the operation of an inverter component of the electric machine and/or initiate an alert for an operator (e.g., an audible or visible indicator displayed by a vehicle in which the electric machine is disposed). A benefit of an electric machine with segmented inverter components, as disclosed herein, is that an individual inverter component can be disabled by, e.g., the supervisory controller or the sub-controller, while other individual inverter components can remain operable to generate torque. In some embodiments, the sub-controller proceeds to operation 225 in response to generating the notification.

FIG. 3 illustrates a flowchart of an example method 300 for a supervisory controller (e.g., supervisory controller 120, FIG. 1), in accordance with embodiments of the present disclosure.

In operation 305, the supervisory controller obtains sensor data. Sensor data can include information such as one or more signals indicating a speed and/or position of a rotor. In some embodiments, the supervisory controller obtains (e.g., receives and/or retrieves) position data from a position sensor (e.g., position sensor 115, FIG. 1). For example, in some embodiments, operation 305 can include the supervisory controller receiving, from an encoder, pulse signals representing an angle of rotation of a rotor. In some embodiments, operation 305 can include the supervisory controller receiving, from a resolver, sine and cosine signals representing an angle of rotation of a rotor.

In operation 310, the supervisory controller generates position data based on the sensor data obtained in operation 305. As discussed above, position data can indicate a position and/or speed of a rotor. In some embodiments, the supervisory controller can generate position data by calculating speed and/or angle values based on signals obtained from a position sensor. For example, in some embodiments, the supervisory controller can generate position data by converting signals of a position sensor to one or more numeric values representing a rotor angle and/or rotor speed. In some embodiments, the supervisory controller can generate position data by converting signals of a position sensor to a PWM signal representing a rotor angle. Such converting can include using the duty cycle PWM relationship discussed with respect to FIG. 2.

In operation 315, the supervisory controller transmits position data generated in operation 310 to one or more sub-controllers (e.g., sub-controller 125-n, FIG. 1). The supervisory controller is configured to transmit one or more numeric speed and/or angle values by a CAN bus. The supervisory controller is further configured to transmit one or more PWM signals by a differential communication channel, as discussed with respect to FIG. 1.

FIG. 4 illustrates an example multi-inverter electric machine 400 having segmented inverter components 430A-D, in accordance with embodiments of the present disclosure. In some embodiments, multi-inverter electric machine 400 can be identical or substantially similar to electric machine 110 discussed with respect to FIG. 1. For example, in some embodiments, segmented inverter components 430A-D and inverters 425A-D can be identical or substantially similar to inverter components 130 and inverters 155, respectively, discussed with respect to FIG. 1. In some embodiments, each of the segmented inverter components 430A-D can include a respective sub-controller (not shown) that is identical or substantially similar to a respective sub-controller 125-n, discussed with respect to FIG. 1. Additionally, supervisory controller 405, position sensor 420, first communication channel 410, and second communication channel 415, can be identical or substantially similar to supervisory controller 120, position sensor 115, first communication channel 140, and second communication channel 145, respectively, discussed with respect to FIG. 1.

Multi-inverter electric machine 400 includes a plurality of modular or segmented inverter components 430A, 430B, 430C, and 430D installed or implemented on stator 435. Each of the plurality of segmented inverter components includes a respective inverter 425A, 425B, 425C, and 425D. Segmented inverter components 430A-D are installed on stator 435 such that each inverter 425A-D is electrically coupled with a set of neighboring teeth 440 (also referred to as poles) in the stator 435. The inverters 425A-D can have any suitable number of phases, but for simplicity, the inverters are illustrated as three-phase inverters, thus coupling with three separate coil windings A, B, and C (using coils 445) in each segmented inverter component 430A-D. For simplicity, the one or more energy sources (e.g., batteries) and the rotor of multi-inverter electric machine 400 are not shown.

In some embodiments, each of the segmented inverter components 430A, 430B, 430C, and 430D is removably attached to the stator, such that the segmented inverter components may be replaced when they become faulty. In some embodiments, such as the one illustrated, four segmented inverter components 430A-D are installed or implemented on stator 435. In some embodiments, each segmented inverter component 430A, 430B, 430C, and 430D is implemented separately and independently of the other segmented inverter components. That is, the inverters 425A-D of the segmented inverter components 430A-D are individually operable or controllable such that if one of the segmented inverter components is removed, there is minimal or no impact or interference to the operation of the remaining segmented inverter components. Thus, each inverter may be controlled separately such that the multi-inverter electric machine 400 is not limited to just a three-phase electric machine. For example, the windings A, B, and C of segmented inverter component 430A can be controlled with a phase shift offset with respect to the windings A, B, and C of segmented inverter component 430B, thereby forming a six-phase inverter.

In some embodiments, supervisory controller 405 can determine which of the inverters 425A-D to be implemented together as well as an offset implemented to increase the number of phases in multi-inverter electric machine 400. In some embodiments, supervisory controller 405 determines which of the segmented inverter components 430A-D, if any, may be not functioning properly and/or in need of replacement. In such case, multi-inverter electric machine 400 can be operated using fewer than the total number of inverters installed in the multi-inverter electric machine 400. Accordingly, such embodiments can avoid using inverter(s) that are determined to be not functioning properly and/or in need of replacement.

FIG. 4 illustrates a non-limiting example configuration; additional configurations are contemplated within the scope of the present disclosure. For example, there may be more than three sets of windings A, B, and C for each segmented inverter component, based on the number of phases in the electric machine. For example, in a six-phase electric machine, there are six sets of windings A, B, C, D, E, and F, each with the appropriate phase offset. The number of windings may be limited by the number of slots in the stator as well as the number of segmented inverter components installed.

FIG. 5 illustrates an example configuration of a differential communication channel 500, in accordance with embodiments of the present disclosure. Differential communication channel 500 includes differential signal transmitter 505, differential conductor 515, and differential signal receiver 510. As discussed above with respect to FIG. 1, in some embodiments, a supervisory controller can include differential signal transmitter 505, and an inverter component can include a differential signal receiver 510.

According to embodiments of the present disclosure, a differential communication channel, such as differential communication channel 500, can provide a number of advantages. For example, differential communication channel 500 can facilitate robust communication and/or a degree of noise immunity. These features can be particularly advantageous, as environments including inverters/motors can generate relatively high levels of electromagnetic interference. Additionally, by incorporating current-fed differential signaling, differential communication channel 500 can reject common mode noise. Additionally, by incorporating impedance controlled and terminated twisted pair cabling, differential communication channel 500 can operate at relatively high frequencies. Additionally, differential communication channel 500 can include higher current than other differential signaling protocols for greater voltage swing at differential signal receiver 510. Differential communication channel 500 can further provide increased signal-to-noise ratio, increased power dissipation, lower maximum speed, and a simulated latency of 140 ns or 0.009 degrees (1°/pulse at 10,000 RPM).

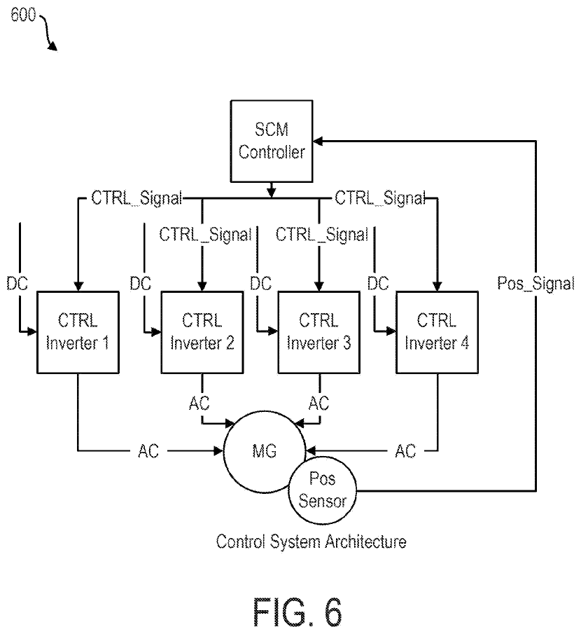

FIG. 6 illustrates an example control system configuration 600, in accordance with embodiments of the present disclosure. Configuration 600 shows DC power provided from a source, such as a vehicle battery.

FIG. 7 is a block diagram depicting an illustrative computing device 700, in accordance with embodiments of the disclosure. The computing device 700 may include any type of computing device suitable for implementing aspects of embodiments of the disclosed subject matter. Each of the various components shown and described in the Figures can contain their own dedicated set of computing device components, such as those shown in FIG. 7 and described below. For example, supervisory controller 120 and each sub-controller 125-n, FIG. 1 can each include a set of components shown in FIG. 7 and described below.

In embodiments, the computing device 700 includes a bus 710 that, directly and/or indirectly, couples one or more of the following devices: a processor 720, a memory 730, an input/output (I/O) port 740, an I/O component 750, and a power supply 760. Any number of additional components, different components, and/or combinations of components may also be included in the computing device 700.

The bus 710 represents what may be one or more busses (such as, for example, an address bus, data bus, or combination thereof). Similarly, in embodiments, the computing device 700 may include a number of processors 720, a number of memory components 730, a number of I/O ports 740, a number of I/O components 750, and/or a number of power supplies 760. Additionally, any number of these components, or combinations thereof, may be distributed and/or duplicated across a number of computing devices.

In embodiments, the memory 730 includes computer-readable media in the form of volatile and/or nonvolatile memory and may be removable, nonremovable, or a combination thereof. Media examples include random access memory (RAM); read only memory (ROM); electronically erasable programmable read only memory (EEPROM); flash memory; optical or holographic media; magnetic cassettes, magnetic tape, magnetic disk storage or other magnetic storage devices; data transmissions; and/or any other medium that can be used to store information and can be accessed by a computing device. In embodiments, the memory 730 stores computer-executable instructions 770 for causing the processor 720 to implement aspects of embodiments of components discussed herein and/or to perform aspects of embodiments of methods and procedures discussed herein. The memory 730 can comprise a non-transitory computer readable medium storing the computer-executable instructions 770.

The computer-executable instructions 770 may include, for example, computer code, machine-useable instructions, and the like such as, for example, program components capable of being executed by one or more processors 720 (e.g., microprocessors) associated with the computing device 700. Program components may be programmed using any number of different programming environments, including various languages, development kits, frameworks, and/or the like. Some or all of the functionality contemplated herein may also, or alternatively, be implemented in hardware and/or firmware.

According to embodiments, for example, the instructions 770 may be configured to be executed by the processor 720 and, upon execution, to cause the processor 720 to perform certain processes. In certain embodiments, the processor 720, memory 730, and instructions 770 are part of a controller such as an application specific integrated circuit (ASIC), field-programmable gate array (FPGA), and/or the like. Such devices can be used to carry out the functions and steps described herein.

The I/O component 750 may include a presentation component configured to present information to a user such as, for example, a display device, a speaker, and/or the like, and/or an input component such as, for example, a microphone, a joystick, a satellite dish, a wireless device, a keyboard, a pen, a voice input device, a touch input device, a touch-screen device, an interactive display device, a mouse, and/or the like.

The devices and systems described herein can be communicatively coupled via a network, which may include a local area network (LAN), a wide area network (WAN), a cellular data network, via the internet using an internet service provider, and the like.

Aspects of the present disclosure are described with reference to flowchart illustrations and/or block diagrams of methods, devices, systems and computer program products. It will be understood that each block of the flowchart illustrations and/or block diagrams, and combinations of blocks in the flowchart illustrations and/or block diagrams, can be implemented by computer program instructions.

Various modifications and additions can be made to the exemplary embodiments discussed without departing from the scope of the disclosed subject matter. For example, while the embodiments described above refer to particular features, the scope of this disclosure also includes embodiments having different combinations of features and embodiments that do not include all of the described features. Accordingly, the scope of the disclosed subject matter is intended to embrace all such alternatives, modifications, and variations as fall within the scope of the claims, together with all equivalents thereof.

Various aspects are described in this disclosure, which include, but are not limited to, the following aspects:
(1) A method comprising: obtaining first position data corresponding to a rotor of an electric machine, the first position data comprising: numeric data indicating a speed and an angle of the rotor; and signal data indicating an angle of the rotor; determining, at a first time, by comparing the speed to a threshold, that the speed exceeds the threshold; generating, based on the signal data and in response to the determining at the first time that the speed exceeds the threshold, a calculated speed and a calculated angle of the rotor; and storing the calculated speed and the calculated angle for controlling the electric machine.
(2) The method of aspect (1) further comprising: determining, by comparing the speed to the calculated speed, that a second threshold is not exceeded, wherein the storing is performed in response to the determining that the second threshold is not exceeded.
(3) The method as in any of the preceding aspects, further comprising: determining, by comparing the speed to the calculated speed, that a second threshold is exceeded; and issuing a notification in response to the determining that the second threshold is exceeded.
(4) The method of aspect (3), wherein the notification indicates a malfunction of an inverter component of the electric machine.
(5) The method as in any of the preceding aspects, further comprising: obtaining second position data corresponding to the rotor, the second position data comprising: second numeric data indicating a second speed and an angle of the rotor; and second signal data indicating an angle of the rotor; determining, at a second time subsequent to the first time, by comparing the second speed to the threshold, that the second speed does not exceed the threshold; and storing, in response to the determining at the second time that the second speed does not exceed the threshold, the second numeric data for controlling the electric machine.
(6) The method as in any of the preceding aspects, wherein the electric machine is a multiphase electric machine having segmented inverter components.
(7) The method as in any of the preceding aspects, further comprising: obtaining the numeric data by a controller area network bus; and obtaining the signal data by a differential two-wire interface.
(8) A system comprising: an electric machine having a rotor and a set of inverter components; a position sensor configured to generate sensor data corresponding to a position of the rotor; a controller communicably coupled to both the position sensor and the set of inverter components, the controller configured to: obtain the sensor data; generate, based on the sensor data, position data; and transmit the position data to each inverter component of the set of inverter components.
(9) The system of aspect (8), wherein the electric machine is multiphase electric machine; and the set of inverter components comprises a set of segmented inverter components.
(10) The system as in any of the preceding aspects, wherein the set of inverter components comprises at least two segmented inverter components.
(11) The system as in any of the preceding aspects, comprising no more than one position sensor.
(12) The system as in any of the preceding aspects, wherein the controller is further configured to: transmit a first portion of the position data to each inverter component of the set of inverter components by a first communication channel; and transmit a second portion of the position data to each inverter component of the set of inverter components by a second communication channel.
(13) The system of aspect (12), wherein the first communication channel comprises a controller area network bus, and wherein the second communication channel comprises a differential two-wire interface.
(14) The system of aspect (12), wherein the first portion comprises numeric data indicating a speed and an angle of the rotor, and wherein the second portion comprises signal data indicating an angle of the rotor.
(15) The system as in any of the preceding aspects, wherein the position data comprises: numeric data indicating a speed and an angle of the rotor; and signal data indicating an angle of the rotor, wherein the set of inverter components includes a first inverter component having a first sub-controller, the first sub-controller configured to: obtain the position data; determine, at a first time, by comparing the speed to a threshold, that the speed exceeds the threshold; generate, based on the signal data and in response to the determining at the first time that the speed exceeds the threshold, a calculated speed and a calculated angle of the rotor; and store the calculated speed and the calculated angle for controlling the electric machine.

1.-15. (canceled)

16. A method comprising:
obtaining first position data corresponding to a rotor of an electric machine, the first position data comprising:
numeric data indicating a speed and an angle of the rotor; and
signal data indicating an angle of the rotor;
determining, at a first time, by comparing the speed to a threshold, that the speed exceeds the threshold;
generating, based on the signal data and in response to the determining at the first time that the speed exceeds the threshold, a calculated speed and a calculated angle of the rotor; and
storing the calculated speed and the calculated angle for controlling the electric machine.

17. The method of claim 16 further comprising:
determining, by comparing the speed to the calculated speed, that a second threshold is not exceeded,
wherein the storing is performed in response to the determining that the second threshold is not exceeded.

18. The method of claim 16 further comprising:
determining, by comparing the speed to the calculated speed, that a second threshold is exceeded; and
issuing a notification in response to the determining that the second threshold is exceeded.

19. The method of claim 18, wherein the notification indicates a malfunction of an inverter component of the electric machine.

20. The method of claim 16 further comprising:
obtaining second position data corresponding to the rotor, the second position data comprising:
second numeric data indicating a second speed and an angle of the rotor; and
second signal data indicating an angle of the rotor;
determining, at a second time subsequent to the first time, by comparing the second speed to the threshold, that the second speed does not exceed the threshold; and
storing, in response to the determining at the second time that the second speed does not exceed the threshold, the second numeric data for controlling the electric machine.

21. The method of claim 16, wherein the electric machine is a multiphase electric machine having segmented inverter components.

22. The method of claim 16, further comprising:
obtaining the numeric data by a controller area network bus; and
obtaining the signal data by a differential two-wire interface.

23. A system comprising:
an electric machine having a rotor and a set of inverter components;
a position sensor configured to generate sensor data corresponding to a position of the rotor;
a controller communicably coupled to both the position sensor and the set of inverter components, the controller configured to:
obtain the sensor data;
generate, based on the sensor data, position data; and
transmit the position data to each inverter component of the set of inverter components.

24. The system of claim 23, wherein the electric machine is multiphase electric machine; and
the set of inverter components comprises a set of segmented inverter components.

25. The system of claim 23, wherein the set of inverter components comprises at least two segmented inverter components.

26. The system of claim 23, comprising no more than one position sensor.

27. The system of claim 23, wherein the controller is further configured to:
transmit a first portion of the position data to each inverter component of the set of inverter components by a first communication channel; and
transmit a second portion of the position data to each inverter component of the set of inverter components by a second communication channel.

28. The system of claim 27, wherein the first communication channel comprises a controller area network bus, and
wherein the second communication channel comprises a differential two-wire interface.

29. The system of claim 27, wherein the first portion comprises numeric data indicating a speed and an angle of the rotor, and
wherein the second portion comprises signal data indicating an angle of the rotor.

30. The system of claim 23, wherein the position data comprises:
numeric data indicating a speed and an angle of the rotor; and
signal data indicating an angle of the rotor.

31. The system of claim 30, wherein the set of inverter components includes a first inverter component having a first sub-controller, the first sub-controller configured to:
obtain the position data;
determine, at a first time, by comparing the speed to a threshold, that the speed exceeds the threshold;
generate, based on the signal data and in response to the determining at the first time that the speed exceeds the threshold, a calculated speed and a calculated angle of the rotor; and
store the calculated speed and the calculated angle for controlling the electric machine.

32. A system for controlling an electric machine, the system comprising:
a rotor;
a position sensor configured to independently detect a position of the rotor and generate sensor data comprising speed data and angle data; and
a supervisory controller configured to:
receive the sensor data from the position sensor;
generate first position information based on the sensor data;
distribute the first position information to a plurality of inverter components via a first communication channel when the speed data is below a threshold;
generate second position information based on the sensor data; and
distribute the second position information to the plurality of inverter components via a second communication channel when the speed data exceeds the threshold,
wherein each of the plurality of inverter components is configured to receive the first position information or the second position information and to control torque applied to the rotor based thereon.

33. The system of claim 32, wherein the first communication channel comprises a controller area network bus and the second communication channel comprises a differential two-wire link.

34. The system of claim 32, wherein the supervisory controller is further configured to apply hysteresis when switching between the first communication channel and the second communication channel based on the speed data.

35. The system of claim 32, wherein each of the plurality of inverter components comprises a sub-controller configured to generate a calculated speed and a calculated angle based on the second position information when the speed data exceeds the threshold.
